(19) United States
(12) Patent Application Publication
(10) Pub. No.: US 2026/0227209 A1
(43) Pub. Date: Aug. 6, 2026

(54) SYSTEMS AND METHODS FOR DETECTING DISTURBANCE EVENTS IN OPTICAL FIBRES

(71) Applicant: FIBER SENSE LIMITED, New South Wales (AU)

(72) Inventors: Peter HUBBARD, Mosman, New South Wales (AU); Nathaniel LINDSEY, Mosman, New South Wales (AU); William BLEWETT, Mosman, New South Wales (AU)

(21) Appl. No.: 19/156,829

(22) PCT Filed: Feb. 13, 2024
(86) PCT No.: PCT/AU2024/050091

§ 371 Date: Aug. 14, 2025

Related U.S. Application Data
(60) Provisional application No. 63/445,613, filed on Feb. 14, 2023.

(51) Int. Cl. G01D 5/353

(52) U.S. Cl. CPC G01D 5/35358

(57) ABSTRACT

There is provided a phase-sensitive optical time domain reflectometry (φ-OTDR)-based method for detecting a disturbance event in an optical fibre. The method includes determining the probability of occurrence of predetermined phase difference values between successive samples of a processed backscattered signal from the optical fibre, to detect the existence or otherwise of the disturbance event.

### TECHNICAL FIELD

The present disclosure generally relates to systems and methods for distributed sensing using one or more optical fibres. More particularly, aspects of the present disclosure relate to systems and methods for detecting disturbance events along the length of an optical fibre.

### BACKGROUND

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

Where a fibre optic cable forms part of a fibre-optic communications network, physical handling/movement of the fibre optic cable, such as moving, pulling, bending and twisting of the cable, physical movements in the environment surrounding the cable fibre, or complete breaks in the fibre optic cable or in one or more optical fibres making up the cable may lead to network errors, network flap events, and/or network outages.

In such networks, it is desirable to detect any such disturbances in the fibre optic cable and/or to detect the precise location of such disturbances as soon as possible so as to prevent or reduce network outages as much as possible, as well as to prevent damage to the fibre optic cable itself.

### SUMMARY

According to a first aspect of the present disclosure, there is provided a phase-sensitive optical time domain reflectometry (φ-OTDR)-based method for detecting a disturbance event in an optical fibre. The method includes determining the probability of occurrence of predetermined phase difference values between successive samples of a processed backscattered signal from the optical fibre, to detect the existence or otherwise of the disturbance event.

In some embodiments, determining the probability of occurrence of predetermined phase difference values between successive samples comprises: determining a threshold number; or determining a threshold percentage over a predetermined time period.

In some embodiments, determining that a disturbance event has occurred upon determining that at least a threshold number of the predetermined phase difference values between successive samples is detected or upon determining that at least a threshold percentage of the predetermined phase difference values between successive samples is detected over the predetermined time period.

In some embodiments, determining the probability of occurrence of the predetermined phase difference values between successive samples comprises generating a histogram of the phase difference values between successive samples and analysing a shape of the histogram to detect the existence or otherwise of the disturbance event.

In some embodiments, the method further comprises determining the existence of a disturbance event if the histogram has a truncated Gaussian shape.

In some embodiments, the method further comprises determining a cable break disturbance event if the histogram has a substantially flat shape.

In some embodiments, the method further comprises determining the location of the disturbance event along the optical fibre based on a timing or other mapping technique pertaining to the processed backscattered signal from the optical fibre.

In some embodiments, the method further comprises determining that the disturbance event is a cable break event upon determining that disturbance events are detected in multiple consecutive locations along the optical fibre.

In some embodiments, the method further comprises determining that the disturbance event is a cable break event upon determining that disturbance events are detected in all locations along the optical fibre downstream from an originating location.

In some embodiments, the predetermined phase difference values are determined based on the phase differences that can be distinguished by the φ-OTDR.

In some embodiments, the predetermined phase difference values comprises one or more phase values, the one or more phase values being in the region of ±π.

In some embodiments, the predetermined phase difference values comprises one or more phase values which are a % of ±π.

In some embodiments, the method further comprises: transmitting an optical signal into the optical fibre; receiving a backscattered optical signal responsive to the transmitted optical signal; combining the backscattered optical signal with an optical reference signal to obtain the processed backscattered signal.

According to a second aspect of the present disclosure, there is provided a method for detecting a disturbance event in an optical fibre. The method includes: transmitting an optical signal in the optical fibre; receiving a backscattered optical signal from the optical fibre responsive to the transmitted optical signal; combining the backscattered optical signal with an optical reference signal to obtain a combined signal; sampling the combined optical signal; determining phase differences between adjacent samples of the sampled combined optical signal; and determining whether a threshold value of the determined phase differences lies in a predetermined phase range to determine whether or not a disturbance event has occurred.

In some embodiments, the method further comprises: determining a location of the disturbance event based on a time difference between transmitting the optical signal in the optical fibre and receiving the backscattered signal from the optical fibre.

In some embodiments, the method further comprises processing the sampled combined optical signal to obtain a spatial differential of the phase of the backscattered optical signal.

In some embodiments, the method further comprises determining whether the disturbance event is a cable break event by determining whether the disturbance event is localized in one or more locations along the optical fibre or detected in all locations along the optical fibre downstream from an originating location where disturbance is detected.

In some embodiments, the spatial differential of the phase of the backscattered optical signal is obtained using a phase-sensitive optical time domain reflectometry (φ-OTDR)-based system.

In some embodiments, the predetermined phase difference values are determined based on the phase differences that can be distinguished by the phase-sensitive φ-OTDR-based system.

In some embodiments, the predetermined phase range comprises one or more phase values, the one or more phase values being in the region of ±π.

In some embodiments, the predetermined phase range comprises one or more phase values which are a % of ±π.

In some embodiments, the predetermined phase values are at least 80% of ±π.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1A illustrates an exemplary arrangement of a distributed fibre optic sensing (DFOS) system.

FIG. 1B illustrates an example plot depicting the intensities of optical signals at different points in the DFOS system.

FIG. 1C illustrates an example plot depicting the optical signal transmitted in to an optical fibre.

FIG. 2 is a flowchart illustrating an example method for detecting a disturbance event according to some embodiments of the present disclosure.

FIG. 3 is a schematic illustrating an example signal processing method for obtaining cumulative phase differential signals from backscattered signals according to some embodiments of the present disclosure.

FIG. 4 is a plot illustrating an exemplary probability of occurrence histogram of spatial and temporal differentials of the optical phase for different cable activities.

### DETAILED DESCRIPTION

As described previously, optical fibre disturbances such as breaks/tears or movements can have a number of adverse impacts both to the cable asset itself and the underlying network of which the cable is a component. Adverse impacts include but are not limited to physical damage to the cable coatings or core, movement of the cable into a more vulnerable position, and/or loss of packets at the physical layer of the internet.

Cable disturbances can be caused by natural events like floods, fires, ground deformation and animal burrowing, or by human activity like normal telecommunication network maintenance, marine vessel anchor drag, construction activity and/or vandalism.

Generally speaking, cable disturbances are a precursor to damage of a cable's coating and/or core, which decreases the useful life of the cable and can lead to progressive degradation of the cable's ability to transmit information or serve its primary purpose.

Some cable disturbances can also cause a temporary loss of packets, often referred to as a network ‘flap’ without physically damaging a cable. Network flap occurs when data packets become unavailable at their destination, and then become available again in rapid succession. This type of event puts stress on the telecommunications system for recalculating the route of the data transmission. The implications of a flap event may vary depending on network topology but may lead to costly network outages. It is well-known that movement of a telecommunications cable by technician handling is a cause of network flap. Other cable disturbances (such as tears or breaks) can cause permanent loss of packets—at least until the break is identified and repaired. The network implications of such disturbances are usually network outage.

Conventionally, a number of different techniques have been employed to detect such cable disturbances or network flap events. In some examples, network flap events are detected at the network layer—e.g., because of an outage or delay in the network—and an alert is issued. If the network flap event is recurring or there is a permanent outage, a telecommunications technician may then inspect the optical fibres using an optical time domain reflectometer to determine the location of the disturbance event. It will be appreciated that disturbance events are typically detected using such techniques many hours after the event and can only be detected if they permanently change the ability of the fibre to transmit optical signals. Until the malfunctioning optical fibre is detected, the network may be operating with reduced reliability.

In other techniques, distributed acoustic sensing (DAS) may be utilized. In a DAS system, a pulse or pulses of laser light are launched into a length of optical fibre and the reflected light that has been scattered within the fibre is analysed in order to derive the nature of the acoustic environment, i.e., any physical vibrations of the fibre transducer. In particular, these systems typically make a measurement of the acoustic strain environment of an optical fibre transducer using an optical time domain reflectometer (OTDR) approach.

In one distributed fibre optic sensing (DFOS) technique, described in international Patent Application WO2021/069481, an optical fibre may be interrogated with optical pulses and the spatial differential of the phase difference between backscattered signals received from the optical fibre and a local oscillator signal may be analysed to measure a value representative of the time differential of the spatial differential of the phase. This measurement is limited by the optical sampling rate of the system to accurately represent the time differential part of the measurement. Since the maximum phase difference measurable by the interferometer is ±π, any phase changes between samples that is larger than this value causes an incorrect measurement. This is particularly problematic for long fibres where the optical sampling rates are necessarily low.

Aspects of the present disclosure overcome one or more issues associated with previously known optical fibre disturbance detection techniques. In particular, aspects of the present disclosure introduce a new optical fibre disturbance detection system that is more precise than previously known systems and can discriminate between data traffic, acoustic disturbances, and/or vibration-induced background noise and disturbance events caused because of cable movement. Further, the presently disclosed systems can be utilized to identify not only movement related disturbances but also breaks in optical fibres. In addition, the presently disclosed systems can not only detect major/permanent damage to optical fibres, but can also detect transient disturbance events that may be precursors to such major/permanent damage. The ability to detect such transient or precursor events is valuable as network outages and/or damages can be prevented even before they occur. Further still, the disclosed systems and techniques allow for prompt diagnosis of or mitigation of subsequent network errors, network flap events, and/or network outages.

In some embodiments, the presently disclosed techniques and systems detect and locate sudden cable movement and breaks using a distributed fibre interferometer that is employed as part of a DFOS system. Generally speaking, the presently disclosed system measures the optical phase of backscattered light along a length of fibre optic cable. This can be achieved by employing a phase-sensitive optical time domain reflectometer (φ-OTDR) that measures the phase evolution of the backscattered signals along an optical fibre. This measured phase can then be differentiated in both time and space. In some embodiments, if a threshold number of the differentiated phase signals fall within predetermined phase ranges, the system can determine that a disturbance event has occurred. Otherwise, it may determine that no disturbance events have occurred. In other embodiments, a histogram can be charted based on the spatial and temporal phase differentials. If the histogram has a particular probability distribution (e.g., flat, non-Gaussian, or truncated), the system can determine that a disturbance event has occurred. Further, based on the shape of the probability distribution curve across its range or part of its range, the type of disturbance event may also be determined, e.g., by comparing the curve with a library of stored curves associated with event types which may be generated using machine learning. By measuring both the spatial and temporal phase differentials, aspects of the present disclosure can detect not only that a disturbance has occurred but also the precise location of that disturbance along a fibre optic cable.

The desired measurement of the spatial and temporal phase differentials are primarily dependent on an optical fibre's refractive index, relative fibre strain change during the time duration between measurements, and variation in the source light's wavelength. Any physical movement of the cable alters the strain and refractive index at a specific location along an optical fibre. By taking the spatial and temporal differentials of the optical phase, both physical location and quantification of the optical phase change within the circular range of the interferometer are performed.

The φ-OTDR typically has two signal detection mechanisms including direct detection and coherent detection. In direct detection, only the intensity of the backscattered optical signal is detected by using a high-sensitivity photodetector. However, the sensing distance may be limited (without amplification). To achieve a longer sensing distance, a complex structure may be required. In coherent detection, local light and a balanced photodetector are used to allow longer sensing distances. It will be appreciated that either of these mechanisms may be employed to obtain the phase signals of the backscattered optical signal without departing from the scope of the present disclosure.

Further, there are mainly three kinds of signal demodulation methods for the system based on coherent detection, including zero-span function of the electrical spectrum analyser (ESA), heterodyne detection, and digital coherent detection. Zero-span function of the ESA can be used to eliminate all the other unwanted electrical components to obtain a pure signal. However, this method is oftentimes not practical for real-time monitoring. In the heterodyne demodulation scheme, a stable local electrical or optical signal (local oscillator) mixes with a backscattered signal where its frequency strictly equals the frequency shift caused by a modulator. However, this synchronous demodulation technique may be sensitive to the variation of the local oscillator signal. Further, the instability of the beat signal can make the signal-to-noise ratio (SNR) of the detection system fluctuate because of the frequency drift of the laser and the modulator.

Any one of these signal demodulation mechanisms may be employed in case a coherent detection φ-OTDR is utilized.

Generally speaking, when an optical signal is transmitted into an optical fibre, every measurement made in the optical fibre is impacted by a length over the optical fibre—i.e., a length of fibre influences a given measurement. That length of the optical fibre is referred to as the spatial resolution of the fibre. A channel as used herein refers to a specific location within a given spatial resolution of the optical fibre. For example, if an optical fibre is 10's of kms long, the optical fibre can be divided into multiple overlapping sections or channels ranging from <1 m to >10 m depending on the configuration. Accordingly, a 100 meter long fibre may be divided into multiple overlapping sections or spatial resolutions and each of these sections/spatial resolutions may be represented by a channel location along the fibre. Further still, as used herein, the term optical gauge refers to the distance between two points along an optical fibre between which the change of phase of the input signal is computed.

The presently disclosed techniques can accurately detect disturbance events and the particular optical channel in which the disturbance event has occurred. In some examples, each optical channel may be 1.6 m apart, while the optical gauge may be 6.4 m, such that disturbances can be detected with a spatial resolution of 6.4 m. This allows the location of outages to be accurately detected in real time thereby reducing downtime significantly.

Reference to fibre optic sensing in this disclosure should be read as including any propagating wave or signal that imparts a detectable change in the optical properties of the sensing optical fibre. These propagating waves or signals detected in the DFOS system may include signal types including one or more of acoustic signals, seismic waves, vibrations, stress to the fibre core, and slowly varying and very low frequency (DC-type) signals such as weight-induced compression waves that induce for example localised strain changes in the optical fibre. The fundamental sensing mechanism in one of the preferred embodiments is a result of the stress-optic effect but there are other sensing mechanisms in the optical fibre that this disclosure may exploit such as the thermo-optic effect.

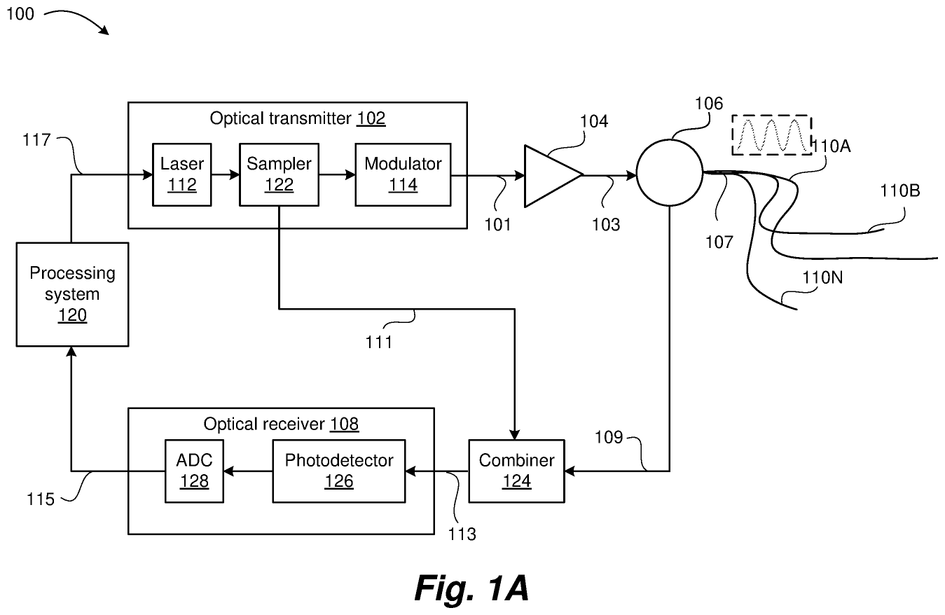

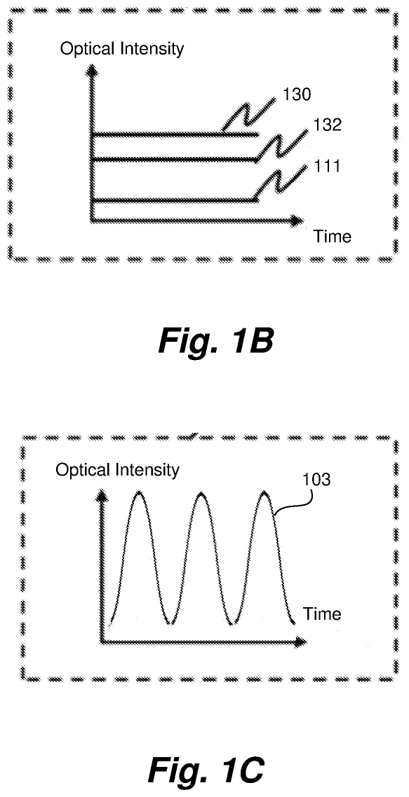

FIG. 1 illustrates an exemplary arrangement of a DFOS system 100 in which aspects of the present disclosure may be implemented. The blocks (in FIG. 1A) represent functional components of the DFOS system 100. It will be appreciated that functionality may be provided by distinct or integrated physical components. Broadly speaking, the DFOS system 100 includes an optical transmitter 102, an optical amplifier 104, an optical circulator 106, a signal receiver 108, and a processing system 120.

The optical transmitter 102 transmits optical signals 101, for example, in the form of repeatedly transmitted optical pulses, into at least one optical fibre 110A, 110B . . . 110N.

In order to do so, the optical signal transmitter 102 includes at least one laser 112 to provide optical signals 101 and at least one modulator 114 to modulate the light. In some embodiments, the at least one laser 112 includes a narrowband continuous wave (CW) laser module that typically utilizes a wavelength between 1500-1600 nm.

Optical signals from the laser 112 are provided to a modulator 114. The modulator 114 is configured to control the power, frequency, phase, shape, polarisation, and/or spatial direction of the interrogating optical signals. Various types of modulators 114 may be used, including but not limited to acousto-optic modulators and electro-optic modulators. The modulator 114 then outputs modulated optical signals (i.e., the optical signals 101) for amplification and/or interrogation.

In some embodiments, the optical signals 101 transmitted by the transmitter 102 are amplified by the optical amplifier 104, resulting in an overall amplification of the optical signals, i.e. amplified optical signals 103, to extend the reach of interrogating signals. The optical amplifier 104 may be a single stage amplifier or a multi-stage optical amplifier. In one example, the optical amplifier 104 includes an Erbium doped fibre amplifier (EDFA). In some embodiments, an optical attenuator may be used (not shown) following the optical amplifier 104 to adjust the power of the amplifier output. In some embodiments, the optical amplifier 104 may be omitted.

In some cases, optical signals generated by the transmitter may be “messy.” In such cases, in addition to amplifying the optical signals, the optical amplifier 104 may also smoothen the messy optical signals into smoother pulses. FIG. 1C illustrates an exemplary optical intensity plot over time of the interrogating optical signals 103 at the output of the amplifier 104. As seen in this plot, the optical signal 103 may be in the form of smooth pulses.

It will be appreciated that although one optical amplifier 104 is shown in FIG. 1A, this need not be the case in all implementations. In some cases, the system may include multiple amplifiers in series. Each amplifier may be a semiconductor optical amplifier (SOA) or an Erbium-doped fibre amplifier (EDFA).

Signals from the optical amplifier 104 are provided to the optical circulator 106. The optical circulator 106 may be configured to direct the optical signals 101 or the amplified optical signals 103 to one of the optical fibres (110A, 110B . . . 110N) as interrogating optical signals 105. In some examples, the interrogating optical signals 105 may include a series of pulses each with power of 0.1-10 mW (such as around but not limited to 0.1, 0.24, 2.8, 5.78, 8, 9.45 and 10 mW) and duration of 1-100 ns (such as around but not limited to 1.23, 4, 25.7, 40.68, 80, 92.3, 99.31 and 100 ns).

The optical circulator 106 also receives returning optical signals 107 backscattered along one or more of the optical fibres (110A, 110B . . . 110N) and outputs backscattered optical signals 109 to the optical signal receiver 108.

The optical receiver 108 receives the backscattered optical signals from the optical circulator 106 and also receives optical signals from the optical transmitter 102. For example, the light from the laser 112 may first enter a sampler 122 (e.g., an optical coupler or an optical splitter), where a first portion of the light is provided to the modulator 114 as outgoing optical signals and a second portion (e.g., the remaining sample portion) of the optical signal is provided as a local oscillator (LO) signal 111. The second portion of the optical signal 111 is combined with the backscattered optical signal via an optical combiner 124 (e.g., an optical coupler). The combined optical signal 113 is then provided to the optical receiver 108, which detects an optically mixed signal, including any beat signal, of the combined optical signal 113. The optical receiver 108 may include an optical detector 126 for detecting one or more optical inputs (e.g., the combined light 113) and producing one or more corresponding electrical outputs (e.g., the optically mixed signal, including any beat signal) as the detected signal. The optical detector 126 may, for example, be in the form of a photodiode for direct detection or be in the form of two photodiodes for balanced detection.

In another example, instead of a sampler, the system 100 may utilize an optical switch. In this case, light from the laser 112 may first enter an input port of the optical switch and exit from one of two output ports, where one output port directs the light to the modulator 114 and the other output port re-directs the light to the optical combiner 124 at a time determined by the processing unit 120. At least one optical delay (not shown) may be applied to synchronise the local oscillator signal 111 and the backscattered optical signal 109 at the optical combiner 124.

When optical signals from the optical transmitter 102 are directed to both the optical amplifier 104 and the optical receiver 108, the proportion to the optical amplifier 104 and/or combiner 124 will typically be smaller, for example 10% or less. FIG. 1B illustrates exemplary optical intensities over time of the light emitted by the laser 130, the light received at the modulator 132, and the optical reference signal 111. As seen in this example, the intensity of the light is less when it reaches the modulator and even lesser when it reaches the combiner 124. The amplifier 104 can amplify the portion to the beam circulator 106, to provide sufficient power of output optical signals for interrogating the fibre optic cables. Similarly, another amplifier (not shown) may be incorporated to amplify the portion of the light that reaches the combiner 124.

In another arrangement, the LO signal 111 may be provided by an optical source separate from the laser 112. The LO signal 111 from the optical source is provided to the optical combiner 124 and is operatively controlled by the processing unit 120. In one example, the optical source may be controlled to emit light with wavelength channels at the same centre frequency as that of the wavelength channels optical signals emitted from the optical transmitter 102. The processing unit 120 may also control the output power and operation time of the optical source. The optical combiner 124 combines the LO signal 111 and the backscattered optical signal 109 and outputs the combined optical signal 113 to the optical receiver 108.

In case a modulator 114 is utilized, the modulator 114 is placed downstream from the sampler 122. This way, unmodulated emission from the optical transmitter 102 or source is provided to the optical combiner 124 as an LO signal 111.

The optical receiver 108 may also include an analog to digital convertor 128 that converts the electrical signals received from the detector into digital signals 115 to be provided to the processing unit 120.

The processing unit 120 may be configured to determine the spatial and temporal phase differentials between adjacent samples of the digitally converted combined signal to detect disturbances in optical signals as described in detail in the following sections.

In some embodiments, the processing unit 120 may also operatively control the optical signal transmitter 102 and/or the optical amplifier via control path(s) 115. For example, one or both of the laser 112 (e.g. its wavelength and/or output power) and the operation of the modulator 114 (e.g. the modulation waveform) of the optical signal transmitter 102 may be controlled by the processing unit 120. In another example, the operation of the sampler 122 and/or the gain of the optical amplifier 104 is controlled by the processing unit 120.

It may also be configured to correlate the detected signals with the coded signals to calculate a lag between the backscattered optical signal and the transmitted optical signal. In one example, correlation includes determining the cross-products between the detected signal and time-delayed versions of the coded signal. In another example, correlation includes determining the cross-products between the coded signal and time-delayed versions of the detected backscattered signal. The processing unit 120 may in some embodiments be configured to recover the envelope of the detected signal. For example, the processing unit 105 includes an envelope detector, a numerical demodulator, or a frequency downconverter, to detect and/or remove the beat frequency in the detected signal prior to determining the correlation. The determined correlation as a function of time delay produces a peak value at a particular time delay. This particular time delay or lag at which the peak correlation value occurs represents the round-trip transit time of the light to the target and back. From this, the distance to the target that reflected the optical signal can be determined.

The at least one optical fibre 110A, 110B . . . 110N may be distributed across a geographical area. In some embodiments, the at least one optical fibre 110 may form part of an established and dedicated fibre-optic communications network (not shown). Techniques for repurposing optical fibres forming part of an established and dedicated fibre-optic communications network are described in international patent application no. PCT/AU2017/050985 (published as WO 2018/045433), the entire content of which is incorporated herein by reference.

It will be understood, the optical fibre 110 is interrogated by sending interrogating optical signals 107 (i.e. a pulse) only when the previous pulse has had time to travel the full length of the fibre and the backscattered light 109 return to the combiner 124. Thus, the backscattered optical signals 109 arriving at the combiner 124 as a function of time after fibre transmission have a time-dependence on the travelled optical fibre distance. The two-way (i.e. outgoing and returning) travel time of the backscattered optical signals 109 is used to multiplex the optical fibre into a series of linear channel positions spanning the entire optical fibre path.

It will be appreciated that other devices other than optical circulators 106 may be used to connect the combiner 124 and the optical fibres (110A, 110B . . . 110N), including but not limited to optical couplers and array waveguide gratings.

The optical signal transmitter 102, the local oscillator 112, and the optical signal receiver 108 (with or without the optical amplifier 104 and the optical circulator 106) may form a phase-sensitive optical time-domain reflectometer (Φ-OTDR).

### Example Method

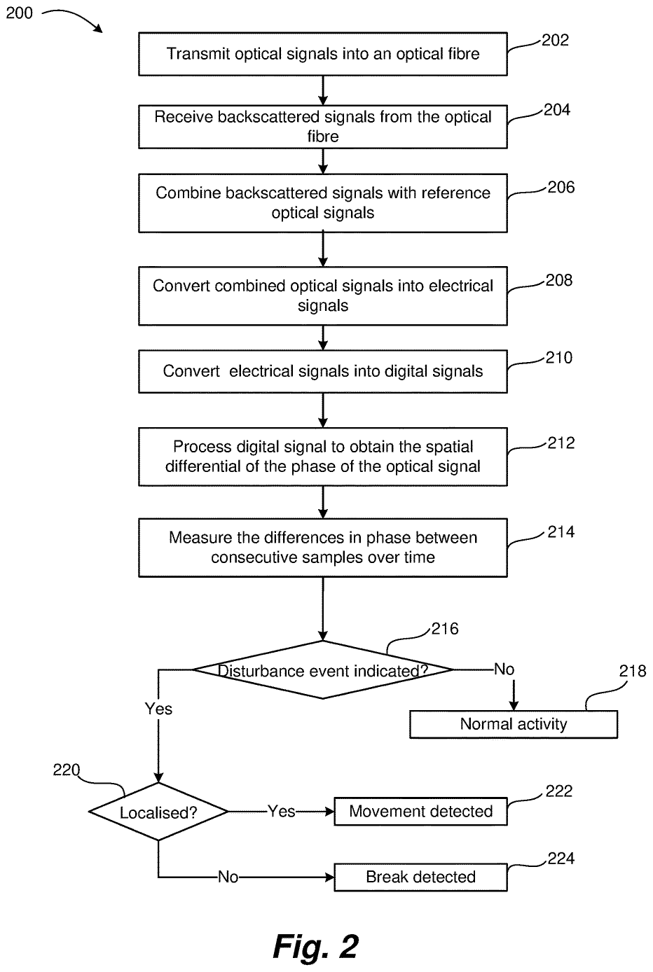

FIG. 2 illustrates an exemplary method 200 for detecting disturbances in optical fibres according to some embodiments of the present disclosure.

The method 200 commences at step 202, where an optical signal (e.g., signal 101 generated by laser 112), for example, in the form of repeatedly transmitted optical pulses, it transmitted into at least one optical fibre 110A, 110B . . . 110N, via circulator 106.

In some embodiments, the optical signals generated by the laser 112 are first modulated by modulator 114 before the optical signals are transmitted into the at least one optical fibre. The modulation may include controlling the power, frequency, phase, shape, polarisation, and/or spatial direction of the optical signals 101. In other embodiments the method further includes amplifying each optical signal with the optical amplifier 104 prior to transmitting each optical signal into the at least one optical fibre 110.

At step 204, the method includes receiving optical signals 107 backscattered along the at least one optical fibre 110 and outputting the backscattered optical signals 109 to the combiner 124. Generally speaking, backscattering refers to light that is reflected or scattered back to its origin due to randomly-distributed variations in the refractive index of an optical fibre, caused by inhomogeneities in the fibre. Several types of backscattering occur in optical fibres. Depending on the wavelength of the backscattering it can be subdivided into three specific types of peaks known as the Rayleigh, Raman, and Brillouin peaks. Further, the spectrum of the backscattered pattern varies as the shape and density of the fibre changes due to bending or twisting.

At step 206, the received optical backscattered signals 109 are combined with reference optical signals 111 in combiner 124. Optical combining occurs where optical signals of the same or similar optical frequencies interfere with one another. The interference produces an optically mixed signal with characteristics (such as amplitude, phase, and/or any beat frequency) detectable in the electrical domain. In some embodiments, the reference optical signal 111 remains constant throughout an “acquisition period” and changes for different acquisition period. An acquisition period is the period of time between a first optical pulse and a second optical pulse and corresponds to the amount of time required by the optical signals to travel to the end of an optical fibre and return to the circulator 106. This acquisition period may vary based on the length of optical fibre being interrogated. For example, if three consecutive transmitted signals have three different wavelengths, then for the first acquisition period (0-T₁), the reference optical signal 111 is maintained at the first wavelength and then for the second acquisition period (T₁-T₂) the reference optical signal is maintained at the second wavelength, and for the third acquisition period (T₂-T₃) the reference signal is maintained at a third wavelength and so on. This way backscattered optical signals corresponding to a given transmitted signal can be combined with a reference signal corresponding to that transmitted signal.

At step 208, the combined optical signals are communicated to the detector 126, which converts the optical signals into electrical signals. In some embodiments, the electrical signals generated by the detector 126 may be in the form of electrical current proportional to a combined amplitude (or intensity) of two electric fields (i.e. E_{BS} and E_{LO}) but dependent on the phase difference of the backscattered optical signals 109 and the reference optical signal 111, respectively. The two electric fields can be expressed mathematically in the following forms, respectively:

$${E}_{L O} ( n , t ) = \frac{1}{2} {E}_{L {O}_{n}} {e}^{\pm i ( {Φ}_{L {O}_{n}} ( t ) - {ω}_{L O} ( t ) \cdot t )} , \qquad ( 1 )$$

$${E}_{B S} ( n , t ) = \frac{1}{2} {E}_{B {S}_{n}} {e}^{\pm i ( {Φ}_{B {S}_{n}} ( t ) - {ω}_{B S} ( t ) \cdot t )} , \qquad ( 2 )$$

where E_{LO}(n, t) is the electric field of the reference optical signal 111 for position n of the optical fibre (i.e., fibre optic channel n) at time t and E_{BS}(n, t) is the electric field of the backscattered optical signals 109 arriving from position n of the optical fibre (i.e. fibre optic channel n) at time t. E_{LO}_{ₙ} is the electric field amplitude of the reference optical signal 111 for fibre optic channel n and E_{BS}_{ₙ} is the electric field amplitude of the backscattered optical signals 109 arriving from fibre optic channel n. Φ_{LO}_{ₙ}(t) is a local phase (i.e. phase for fibre optic channel n) at time t for the reference optical signal 111 and Φ_{BS}_{ₙ}(t) is a local phase (i.e. phase for fibre optical channel n) at time t for the backscattered optical signals 109. ω_{LO}(t) is an instantaneous carrier frequency for the reference optical signal 111 and ω_{BS}(t) is an instantaneous carrier frequency for the backscattered optical signals 109.

The time-dependent superposition (combination) of the reference optical signal 111 and the backscattered optical signals 109 (i.e., the combined optical signal 113) at the at least one photodetector 126 yields electrical signals (i.e., a photocurrent (I)) in the following form:

$$I = {E}_{BS}^{2} ( t ) + {E}_{LO}^{2} ( t ) + 2 {E}_{B S} ( t ) {E}_{L O} ( t ) cos ( ( {ω}_{L O} - {ω}_{B S} ) t + {Φ}_{L O} ( t ) - {Φ}_{B S} ( t ) ) , \qquad ( 3 )$$

where φ_{BS}(t)) is the time evolution of the cumulative optical phase of the backscattered optical signals 109, φ_{LO}(t) is the time evolution of the cumulative optical phase of the reference optical signal 111, indicating a change in the local phase, and Δω is a difference between the instantaneous carrier frequencies of the reference optical signal 111 and the backscattered optical signals 109, called carrier frequency of the electrical signals 207.

As shown in Equation (3), the electrical signals include a DC term related to the scattered light intensity; a DC term related to the local oscillator intensity; a negative frequency term which is centred at the difference frequency between the local oscillator and scattered light waves; and a positive frequency term which is centred at the difference frequency between the local oscillator and scattered light waves. The positive and negative frequency terms also carry information about the phase difference between the local oscillator and scattered light waves at a time, t. As a result, it is only necessary to analyse one of the positive or negative frequency terms in order to recover the phase information.

At step 210, the electrical signals generated by the detector 126 are converted into digital signals by the ADC 128—i.e., continuous electrical signal are converted into discrete samples. In particular, the ADC 128 may be configured to output signal samples representative of the interference between a backscattered signal 109 that was scattered from a location along an optical path and a local oscillator signal 111, as discussed above.

At step 212, the processing system 120 processes the digital signal to determine whether a disturbance event has occurred in the optical fibre or not. In order to do so, the processing system 120 first obtains the spatial differential of the phase of the optical signal. In order to recover information relating to the phase of the optical signal, the processing system 120 typically digitally down converts the optical signal to recover only the positive frequency term, and then transforms the signal from rectangular to polar coordinate. This process is equivalent to a complex multiplication and has the effect of shifting the positive frequency term, or carrier, down to DC and then filtering the signal to remove what was the DC terms and the negative frequency term. That is, the recovered signal is around the positive frequency peak. At this stage since the wanted bandwidth and hence the bandwidth of the low pass filter is less than the carrier frequency, there is in effect a complex carrier at baseband, centred at 0 Hz.

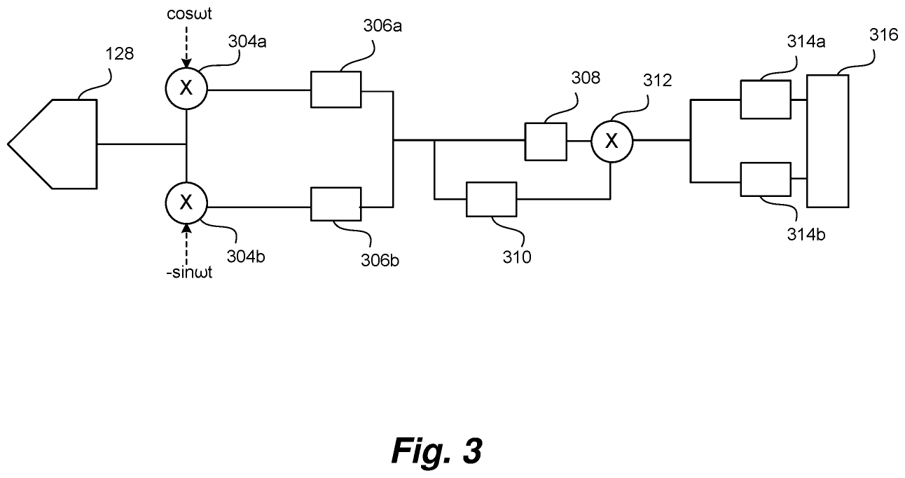

FIG. 3 is a schematic diagram showing exemplary signal processing steps performed by the processing system 120 to obtain the spatial differential of the phase of the optical signal. It will be understood that the cumulative optical phase of the backscattered optical signal 109 can be detected via complex or real detection. The exemplary arrangement in FIG. 3 employs real detection followed by complex manipulation of the signals in the digital domain.

The method 300 starts where the output signal of the ADC 128, which is a real carrier signal, is split into two parts, with one part being multiplied by an in-phase component (cos(ωt)) 304a and the other part being multiplied by a quadrature component (−sin(ωt)) 304b. This has the effect of shifting the carrier signal down, such that the desired positive frequency term is centred at DC.

Each of the two parts is then passed through a lowpass filter 306a, 306b to remove the unwanted terms and the outputs of the lowpass filter 306a, 306b are recombined into a complex signal. This recombined signal is a first complex carrier signal, which is modulated by a phase difference between the local oscillator signal 111 and the scattered signal 109. At this point, the complex carrier signal shows the cumulative phase acquired by the backscattered signal.

The first complex carrier signal is again divided into two parts. A first part of the complex carrier signal undergoes complex conjugation 308, while a second part of the first complex carrier signal is delayed 310 by an amount equal to the gauge length set by an operator. This gauge length effectively decides the spatial resolution of the system, as it determines the distance between locations n and n+1 in the optical fibre. The gauge length may be on the order of several meters. The conjugated part of the first complex carrier signal and the delayed part of the first complex carrier signal are then multiplied 312, generating a second complex carrier signal that is modulated by a spatial differential of the phase difference. The second complex carrier signal, being generated in this way, therefore carries the spatial differential phase of the scattered signal.

The second complex carrier signal is divided into two parts, real and imaginary, with each part being sent to a lowpass filter 314a, 314b. Each filtered part is passed to a rectangular-to-polar coordinate (R-P) converter 316, from which can be derived a value representative of the spatial differential of the phase difference for the location along the optical path.

It will be appreciated that the signal processing described with reference to FIG. 3 is just one example method for processing the ADC signals to obtain the spatial phase signal differential. Other signal processing methods may also be employed. For example, in case a first test pulse and a second test pulse were transmitted to an optical fibre, where the second test pulse is delayed relative to the first test pulse and the first test pulse and the second test pulse have different frequencies, the ADC 128 may be configured to output a signal representative of the interference between a backscattered signal that was scattered from a location along an optical path and a local oscillator signal for each of the two test pulses.

In such cases, the output signal of the ADC 128 is divided such that the signal which results from each test pulse is processed separately before being multiplied together at a later stage. It should be noted that each test pulse may be generated from a single laser and modulator which can be operated to output a first test pulse and a second test pulse. The time delay between the first test pulse and the second test pulse sets the spatial gauge length for the delay in step 210.

In such case, the output signal of the ADC 128, which is a real carrier signal, may be split between two paths. A first path processes the result of the first test pulse, and the second path processes the result of the second test pulse.

Considering the first test pulse, a first complex signal is generated (as discussed above). At this point, the first complex carrier signal shows the cumulative phase acquired by the scattered signal from the first test pulse. The first complex carrier signal then undergoes complex conjugation (as discussed above). This process is repeated for the second test pulse, to obtain a first complex carrier signal for the second test pulse.

The conjugate of the first complex carrier signal for the first pulse can then be multiplied with the first complex carrier signal for the second pulse. This generates a second complex carrier signal that carries the spatial differential phase of the scattered signal. In this respect, with comparison to the method described with respect to FIG. 3, there is no need to introduce a gauge delay as the gauge delay naturally results from the time delay between the first test pulse and the second test pulse.

The second complex carrier signal can again be divided into two parts, real and imaginary, with each part being sent to a low-pass filter and then a rectangular-to-polar coordinate (R-P) converter 316, from which can be derived a value representative of the spatial differential of the phase for the location along the optical path.

It will be appreciated that these are only two methods of obtaining the spatial differential of the phase and that other signal processing method may be used without departing from the scope of the present disclosure to obtain the spatial differential of the phase.

After conversion to polar coordinates, the signal information is in the form of amplitude and phase over distance along the optical fibre, differentiated in space by the gauge length of the system. From this signal information, disturbance events in the optical fibre may be detected by the processing system 120.

In one example, at step 214, the processing system 120 measures the phase difference between consecutive samples over time (ΔdΦ), which corresponds to performing a time differential of the signal information obtained at the end of step 210. In some examples, this measurement is obtained by calculating the difference in phase values between consecutive pairs of signal samples.

At step 216, the processing system 120 determines whether a disturbance event is detected. This may be determined in a number of ways. In one embodiment, the processing system 120 determines whether a threshold number of the phase differences between consecutive samples falls within a predetermined phase range. In one example, the phase range may be values close to one or both ends of the phase spectrum, e.g., −π and π. For example, the predetermined phase ranges may be −π to −0.8π and/or 0.8π to π. In other examples, the predetermined phase ranges may be phase values such as −π and/or π. In some embodiments, the predetermined phase ranges or values may be determined based on the phase differences that can be distinguished by the interferometer or φ-OTDR. If the φ-OTDR can distinguish phase differences in the range −π/2 to π/2, the predetermined phase ranges may be −π/2 to −0.8π/2 and/or 0.8π/2 to π/2. In other examples, the predetermined phase ranges may be phase values such as −π/2 and/or π/2.

If the number of phase differences between consecutive samples that fall within the predetermined phase range/predetermined phase value exceed the threshold value, then the type of event associated with the measured phase is classified as a disturbance event (yes path from step 216). Further, the location of the disturbance is determined based on the timing of receiving the corresponding backscattered signal.

Alternatively, if the number of phase differences between consecutive samples that fall within the predetermined phase range/predetermined phase value is less than the threshold value, the type of event associated with the measured phase is classified as any other type of event including a cable operating under normal conditions at step 218.

If no disturbance events occur in the optical fibre during interrogation, the differences in phase values between consecutive samples is minimum, with very few phase difference values falling in the above described predetermined phase ranges. On the other hand, if disturbance events occur in the optical fibre during interrogation, the differences in phase values between consecutive samples may be large, with many consecutive samples falling in the predetermined phase ranges. Accordingly, by selecting a suitable threshold number (e.g., 5 or 10), the processing system 120 may be precisely and accurately able to discriminate between regular activity in the fibre optic cables and disturbance events.

In other embodiments, instead of a threshold number, a threshold percentage over time may be used (e.g., 60% or 70% of samples over 30 seconds). The system may then determine the percentage of phase differences between consecutive samples over time that fall within the predetermined phase range/predetermined phase values. If the percentage over time is equal to or higher than the threshold percentage over time, the type of event associated with the measured phase is classified as a disturbance event and if the percentage over time is lower than the threshold percentage over time it is classified as normal activity.

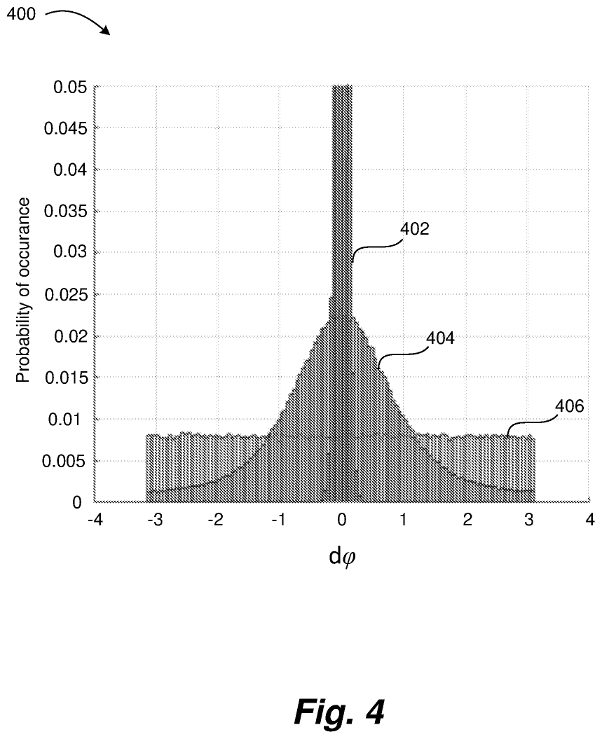

FIG. 4 shows a histogram of occurrence plot of the phase differences between consecutive phase samples over time (ΔdΦ) for channels along an optical fibre in an urban environment exhibiting different types of activity. In particular, the plot shows ΔdΦ values measured along the fibre at channels where nothing abnormal is occurring 402, where a technician is handling the fibre (i.e., the channel is experiencing cable movement 404), and downstream from a cable break 406. A φ-OTDR system employing coherent detection and complex carrier manipulation to determine the spatial differential of phase is used. The spatial differential of phase is then differentiated from one sample to the next (i.e. differentiated in time at each channel). The optical sampling rate was 2 kHz.

FIG. 4 shows that phase difference values between consecutive samples for a cable operating under normal conditions 402 is centred around zero (i.e., there are typically very low phase differences between adjacent samples). In particular, it can be seen that the phase histogram 402 under normal condition is detected in its entirety without any truncation. This is because a fibre optical cable operating under normal conditions does not usually face any changes in the strain and refractive index at specific locations of the fibre, thus the differential phase of the backscattered signal is substantially not changed in that the phase evolution between successive samples/in adjacent channels remains close to zero.

A cable experiencing movement 404 or breakage 406 is characterised by a probability of occurrence of temporally and spatially differentiated phase samples that are truncated at the ends of the phase range e.g., [−π, π] in this example. In particular, the histograms are truncated at the lower and upper limits of this range.

The inventors have postulated two main reasons to explain the behaviour of the phase differences during cable movement 404 or breakage 406. During physical movement or breakage, changes in the strain and refractive index at a specific location of the fibre occurs, thus drastically changing the differential phase of the backscattered signal-such that consecutive signal samples do not occur fast enough to capture the phase change within the range of [−π, π]. When cable movements occur, the channel experiencing the movement is attempting to measure strain changes that are too fast for a system with a limited sampling rate due to a long optical fibre where the length determines the maximum pulse repetition (i.e. sampling) rate. For such events, the histogram 404 appears truncated as a number of the phase difference samples are completely out of the range or even greater than or less than the limits of the phase range of the system, with the result that the measured phase difference value aliases for example from +π to −π and vice-versa.

When cable breakage occurs, the histogram 406 is truncated because the system is measuring pure noise. Thus, the phase difference samples 406 are evenly distributed through the phase range.

Aspects of the present disclosure leverage these truncations in phase difference values between adjacent samples to detect cable movement and breaks. The inventors have realised that this truncation that occurs when measuring phase difference in cables experiencing movements or breakage can be leveraged to detect these events. In particular, a channel under normal circumstances 402 will not exhibit temporally and spatially differentiated phase truncated at ±π. Thus, recording a truncated phase difference signal at ±π allows for signal discrimination of movement events or breakage even in noisy urban environments where a phase difference value of ±π is clearly distinguishable over noise. This is especially true when the optical configuration of the system is set up under normal circumstances when un-truncated histograms can be observed before any disturbance events. This a-priori information allows for the disturbance events to be clearly discriminated based on the detection of truncation.

In another embodiment, instead of determining whether a threshold number of the phase differences between consecutive samples falls within a predetermined phase range, the processing system may measure phase difference values across the entire phase spectrum over a time period (e.g., 30 seconds) to yield a histogram (such as histogram 400). The system may then analyse the shape of the histogram 400 and determine whether a disturbance event is indicated. For example, if the histogram is truncated, the processing system 120 may determine that a disturbance event has occurred. Similarly, if the histogram 400 has a flatter profile or a non-Gaussian profile, the processing system 120 may determine that a disturbance event has occurred.

If a disturbance is detected at step 216, the method proceeds to step 220 to determine whether the disturbance is localised or not—i.e., if the disturbance event is a local flap or movement event or a cable break event. In some embodiments, the processing system 120 may determine that the disturbance is movement related if the disturbance event is localised to one or more localised channels of the optical fibre. For example, it may determine that the disturbance event is a localized event if a threshold number of the phase differences between consecutive samples fall within a predetermined phase range for one or more of the channels. In another example, the processing system 120 may determine that the disturbance event is localized based on the shape of the histogram 400—e.g., if the histogram has a truncated Gaussian profile. Alternatively, the processing system 120 may determine that the disturbance event is related to a break in the cable if every channel downstream of the break results in a disturbance event. For example, it may determine that the disturbance event is a cable break event if a threshold number of the phase differences between consecutive samples fall within a predetermined phase range for all the channels downstream of a first channel. In another example, the processing system 120 may determine that the disturbance event is a cable break event based on the shape of the histogram 400—e.g., if the histogram has a flat profile.

In summary, as discussed above, the present invention enables the detection and location of sudden cable movement and/or breakage by measuring the occurrence of temporally and spatially differentiated phase samples at the ends or edges of the phase range of the φ-OTDR. This may correspond to measuring phase difference values at ±π or at phase difference values which are a % of or in the region of ±π, such as any value or range of values from 80%-99%±π.

It will be understood that the invention disclosed and defined in this specification extends to all alternative combinations of two or more of the individual features mentioned or evident from the text or drawings. All of these different combinations constitute various alternative aspects of the invention.

As used herein, except where the context requires otherwise, the term “comprise” and variations of the term, such as “comprising”, “comprises” and “comprised”, are not intended to exclude further additives, components, integers or steps.

1. A phase-sensitive optical time domain reflectometry (φ-OTDR)-based method for detecting a disturbance event in an optical fibre, the method including:
determining the probability of occurrence of predetermined phase difference values between successive samples of a processed backscattered signal from the optical fibre, to detect the existence or otherwise of the disturbance event.

2. The method of claim 1, wherein determining the probability of occurrence of predetermined phase difference values between successive samples comprises:
determining a threshold number; or
determining a threshold percentage over a predetermined time period.

3. The method of claim 2, further comprising determining that a disturbance event has occurred upon determining that at least a threshold number of the predetermined phase difference values between successive samples are detected or upon determining that at least a threshold percentage of the predetermined phase difference values between successive samples are detected over the predetermined time period.

4. The method of claim 1, wherein determining the probability of occurrence of the predetermined phase difference values between successive samples comprises generating a histogram of the phase difference values between successive samples and analyzing a shape of the histogram to detect the existence or otherwise of the disturbance event.

5. The method of claim 4, further comprising determining the existence of a disturbance event if the histogram has a truncated Gaussian shape.

6. The method of claim 4, further comprising determining a cable break disturbance event if the histogram has a substantially flat shape.

7. The method of claim 1, further comprising determining the location of the disturbance event along the optical fibre based on a timing or other mapping technique pertaining to the processed backscattered signal from the optical fibre.

8. The method of claim 1, further comprising determining that the disturbance event is a cable break event upon determining that disturbance events are detected in multiple consecutive locations along the optical fibre.

9. The method of claim 1, further comprising determining that the disturbance event is a cable break event upon determining that disturbance events are detected in all locations along the optical fibre downstream from an originating location.

10. The method of claim 1, wherein the predetermined phase difference values are determined based on the phase differences that can be distinguished by the φ-OTDR.

11. The method of claim 1, wherein the predetermined phase difference values comprises one or more phase values, the one or more phase values being in the region of ±π.

12. The method of claim 1, wherein the predetermined phase difference values comprises one or more phase values which are a % of ±π.

13. The method of claim 12 wherein the predetermined phase values are at least 80% of ±π.

14. The method of claim 1, further comprising:
transmitting an optical signal into the optical fibre;
receiving a backscattered optical signal responsive to the transmitted optical signal; and
combining the backscattered optical signal with an optical reference signal to obtain the processed backscattered signal.

15. A method for detecting a disturbance event in an optical fibre, the method including:
transmitting an optical signal in the optical fibre;
receiving a backscattered optical signal from the optical fibre responsive to the transmitted optical signal;
combining the backscattered optical signal with an optical reference signal to obtain a combined signal;
sampling the combined optical signal;
determining phase differences between adjacent samples of the sampled combined optical signal; and
determining whether a threshold value of the determined phase differences lie in a predetermined phase range to determine whether or not a disturbance event has occurred.

16. The method of claim 15, further comprising: determining a location of the disturbance event based on a time difference between transmitting the optical signal in the optical fibre and receiving the backscattered signal from the optical fibre.

17. The method of claim 15, further comprising processing the sampled combined optical signal to obtain a spatial differential of the phase of the backscattered optical signal.

18. The method of claim 15, further comprising: determining whether the disturbance event is a cable break event by determining whether the disturbance event is localized in one or more locations along the optical fibre or detected in all locations along the optical fibre downstream from an originating location where disturbance is detected.

19. The method of claim 15, wherein the spatial differential of the phase of the backscattered optical signal is obtained using a phase-sensitive optical time domain reflectometry (φ-OTDR)-based system.

20. The method of any one of claim 19, wherein the predetermined phase difference values are determined based on the phase differences that can be distinguished by the phase-sensitive φ-OTDR-based system.

21-23. (canceled)
